(19) United States
(12) Patent Application Publication
(10) Pub. No.: US 2013/0159208 A1
(43) Pub. Date: Jun. 20, 2013

(54) SHIPPER-ORIENTED LOGISTICS BASE OPTIMIZATION SYSTEM

(71) Applicants: Byung Jun SONG, Gyeonggi-do (KR); Hyun Chul SEUNG, Seoul (KR); Seon Min HWANG, Gyeonggi-do (KR)

(72) Inventors: Byung Jun SONG, Gyeonggi-do (KR); Hyun Chul SEUNG, Seoul (KR); Seon Min HWANG, Gyeonggi-do (KR)

(21) Appl. No.: 13/404,427

(22) Filed: Feb. 24, 2012

(30) Foreign Application Priority Data
Dec. 19, 2011 (KR) KR10-2011-0137119

(51) Int. Cl. G06Q 10/08

(52) U.S. Cl. 705/338

(57) ABSTRACT

A logistics base optimization system that may provide an optimal plan with respect to an architecture of a logistics network of a shipper, the number and capacity of logistics centers, a transport network, a routing, and the like, in order to minimize logistics cost or a carbon emission amount at the present, midterm, and long term.

### CROSS-REFERENCE TO RELATED APPLICATIONS

This application claims priority to and the benefit of Korean Patent Application No. 10-2011-0137119 filed in the Korean Intellectual Property Office on Dec. 19, 2011, the disclosure of which is expressly incorporated by reference herein in its entirety.

### TECHNICAL FIELD

The present invention relates to a knowledge-based service for optimal decision making of a shipper-oriented smart logistics network in order to enable minimization of logistics cost to decrease a carbon emission amount, and to quickly and economically cope with a dangerous situation such as logistics chaos and the like by ensuring competitiveness of industry logistics, and more particularly, to a shipper-oriented logistics base optimization system for providing an optimal plan in terms of an architecture of a logistics network of a shipper, a number and capacity of logistics centers, a transport network, a routing, and the like, in order to minimize logistics cost or a carbon emission amount at the present, midterm, and long term.

### BACKGROUND ART

Generally, the concept of a distribution includes activities of transferring goods and providing a service from a producer to a consumer and creating the utility of a place, a time, and a possession, whereas the concept of logistics is defined as a part of creating the utility of the place and the time excluding a transaction that satisfies the utility of the possession.

Specifically, the concept of the distribution includes all processes of transporting, loading and unloading, storing, packing produced products and a goods distribution such as distribution processing, basic transport facility, and the like, and also includes an information distribution concept such as basic communication facility, an information network, and the like.

Accordingly, logistics generally indicates a part associated with national key industrial activities, such as the basic transport facility, the basic communication facility, and the like, and transporting, storing, loading and unloading, packing, distributing, processing, and information functions that may be managed by a company itself.

Meanwhile, a complex logistics system indicates a logistics system that classifies cargo as air cargo in the step of packing cargo and then enables the classified cargo to pass a border without requiring a separate inspection during the subsequent marine/land transport process. Accordingly, when a cargo truck that is used to directly transport shipped cargo overseas sends the cargo from the domestic country sends cargo to a different country by airplane, the complex logistics system allows the cargo truck to directly transport the cargo to an airport without requiring a separate inspection procedure. Accordingly, it is possible to decrease damage to cargo when unloading the cargo and labor cost. In addition, it is possible to accelerate logistics transport.

A logistics management information system that is a part of an intelligent transport system (ITS) is a logistics operation system for optimizing and efficiently managing a truck service through an automated fare collection, safe driving, prevention of an empty car on the way back home, and the like, by automatically verifying a position of a cargo vehicle, a type of loaded cargo, a driving state, a route situation, cargo conciliation information, and the like. In addition, the logistics management information system is a system for decreasing a vehicle accident or delay while driving by automatically detecting a state of a vehicle and thereby warning a driver and a manager in advance.

Therefore, nowadays, it is needed to develop a technology that may quickly cope with rapidly changing global economy and an environmental crisis oriented for green growth, and may also continuously evaluate and develop a supply network management of a company.

Also, it is required to simulate a design of a supply network while providing countermeasures that may quickly cope with an unexpectedly occurring emergency situation.

In the conventional logistics network optimization technology, a distance/time generation technology for each section using a geographic information system (GIS) is commercialized. However, there is no optimization technology that provides dynamic route generation to integrate and consider an entire consumer-oriented logistics network and service using the same.

Also, the Korean Electronics and Telecommunications Research Institute (ETRI) has developed a postal logistics network simulation technology that may perform load analysis according to a future change in the quantity over the midterm and long term timeline with respect to a postal logistics network based on a mail center, and may simulate in advance the effects according to countermeasures.

Therefore, the above existing technology supports a plan establishment for efficient operation of existing logistics infrastructure focusing only on a planning itself. Until now, there is no intelligent optimization and simulation technology that may monitor an operation in real time and thereby provide an appropriate plan when an exceptional situation and a problem occur. Also, a level of an original of logistics technology associated with an environment is very low and is highly dependent on technology developed countries such as the United States, Japan, and the like. Due to a technology protection policy of such developed countries, it is difficult to secure the technology in the developing countries.

Accordingly, the present applicant has developed a knowledge-based logistics service for optimal decision making of a shipper-oriented smart logistics network that may secure competiveness of industry logistics and may rapidly and actively cope with a dangerous situation such as logistics chaos by saving logistics cost and reducing a carbon emission amount with living in a low carbon emission and green growth era.

### SUMMARY OF THE INVENTION

The present invention has been made in an effort to provide a shipper-oriented logistics base optimization system that may optimize a transport/delivery route using optimization and time efficiency, may provide induction of an optimal route of an associated transport, and a logistics cost, a consumed time, a carbon emission amount, and the like of a corresponding route when a transport service is completed, using a process to an environment-friendly transport means, and may also figure out which result is best suitable for each optimization purpose.

An embodiment of the present invention provides a shipper-oriented logistics base optimization system, wherein, through smart logistics networking with a logistics integrated database and a standard interface constructed and operated to generalize logistics related data by processing and analyzing collected information based on a total logistics information network and a current logistics situation survey together with an active logistics management optimization module and a simulation module in a server, the shipper-oriented logistics base optimization system is configured to perform: an input process of receiving a center, a destination (customer), a service area, the quantity of transported goods (order information), and a vehicle in the optimization module and the simulation module; a simulation process of generating a route by setting a constraint condition and then performing geo-coding; an interface process of providing a primary order to an n^{th} order in an interface manager through the route generation; an analysis process proceeding to a determination process while feeding the number of vehicles, the number of turns, a total travel distance, and cost back to the simulation process as a result analysis; and the determination process of predicting a change in a preoperational environment in an operation of a new customer company, evaluating an existing service area, designating an optimal service area for delivery, predicting a change when the quantity of transported goods of an existing customer increases or decreases, and determining whether a new delivery base is suitable.

Another embodiment of the present invention provides a shipper-oriented logistics base optimization system, wherein a reference information step, a transport plan step, a vehicle delivery/carryout step, a transport performance step, and a transport strategy step are performed with an enterprise order information (ERP) system, an integrated optimization system, and an enterprise executive system (TMS) whereby an integrated optimization system of a smart logistics network performs a simulation preparation by collecting per-quarter planning data with respect to quantity information (cubic meter (CBM) and PLT) and by deducing a PLT coefficient as transport performance, performs a simulation carryout of planning by receiving order information and verifies a result of report, and transmits a result confirmation of the planning to the transport plan step by performing route optimization using route information through establishment of a transport strategy.

According to the embodiments of the present invention, it is possible to promote an optimal design and operation of an environment-friendly logistics network in consideration of optimization of a carbon emission amount by establishing a transport/delivery plan. Also, it is possible to establish a stable logistics network plan with a quicker time and lower cost for improving the effectiveness and efficiency of the logistics network.

Also, according to the embodiments of the present invention, it is possible to efficiently improve a complex logistics procedure through optimization of a carbon emission amount, and to strengthen the competiveness of logistics by establishing a logistics optimization plan.

### BRIEF DESCRIPTION OF THE DRAWINGS

FIG. 1 is a block diagram to describe a shipper-oriented logistics base optimization system according to an embodiment of the present invention.

FIG. 2 is a process to describe a logistics network optimization module and a simulation module of an integrated optimization system.

FIG. 3 is a process in which a reference information step, a transport plan step, a vehicle delivery/carryout step, a transport performance step, and a transport strategy step are performed with an enterprise order information (ERP) system, an integrated optimization system, and an enterprise executive t system (TMS).

FIGS. 4 and 5 are processes performed in a simulation process.

FIG. 6 is a flowchart illustrating planning of a transport strategy step in detail.

FIGS. 7 through 13 are views displayed on a screen of each item using an interface manager.

FIG. 14 is a process of a transport strategy constraint condition illustrating constraint condition items of a router designer.

FIGS. 15 through 17 are views displayed on a screen of each item using an interface manager.

FIGS. 18 and 19 are screens displaying routes to describe a shipper-oriented logistics base optimization system of the present invention.

### DETAILED DESCRIPTION

Hereinafter, embodiments of the present invention will be described in detail with reference to the accompanying drawings.

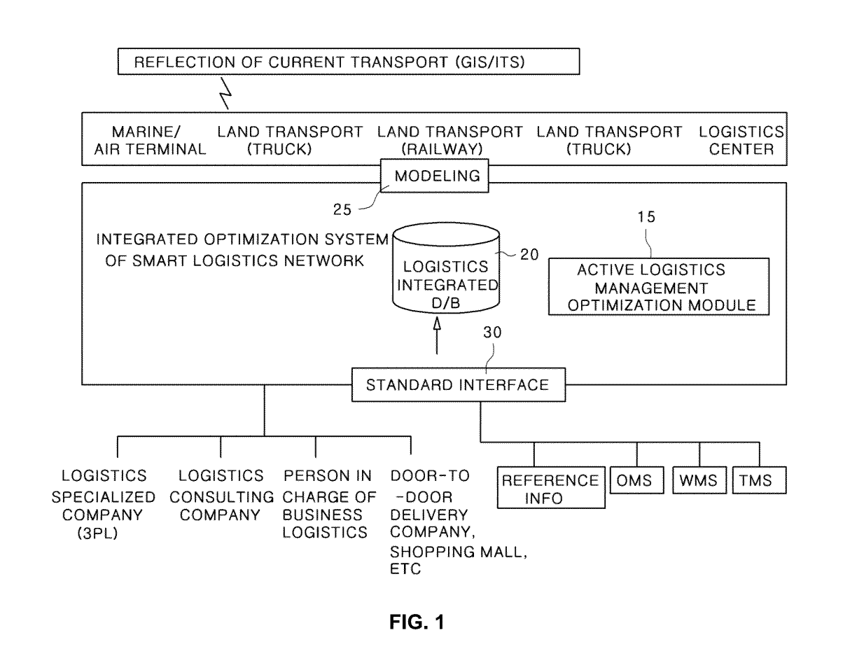

FIG. 1 is a diagram to describe a shipper-oriented logistics base optimization system according to an embodiment of the present invention. The present invention relates to a shipper-oriented logistics base optimization system for providing an optimal plan in terms of an architecture of a logistics network of a shipper, the number and capacity of logistics centers, a transport network, a routing, and the like, in order to minimize logistics cost or a carbon emission amount at the present, midterm, and long term.

Accordingly, it is possible to construct a knowledge-based service for optimal decision making of a shipper-oriented smart logistics network in order to enable minimization of logistics cost to decrease the carbon emission amount, and to quickly and economically cope with a dangerous situation such as logistics chaos and the like by ensuring the competiveness of industrial logistics. Therefore, the knowledge-based service of the present invention is considered to be a highly invested service in terms of research and development (R&D) activity, an information technology (IT), skilled manpower, and the like, among production support services that are used as an intermediary medium of a production activity to complement or replace an internal function of a company.

A logistics base among suppliers reflects a current transport network state of a geographical information system (GIS)/intelligent transportation system (ITS) for a shipper-oriented smart logistics network service and is modeled 25, for example, so as to be transported at marine and air terminals by a land transportation means such as a truck, a railroad, and the like into a logistics center, and to then, finally be transported into an integrated logistics center.

Here, an integrated optimization system 10 of a smart logistics network is mutually used in a logistics specialized company (third party logistics (3PL)), a logistics consulting company, a person in charge of company logistics, a door-to-door delivery company, a shopping mall, and the like. That is, the integrated optimization system 10 performs smart logistics networking with a logistics integrated database 20 and a standard interface 30 constructed and operated to generalize logistics related data by processing and analyzing collected information based on a total logistics information network and a current logistics situation survey together with an active logistics management optimization module 15 and a simulation module in a server.

The integrated optimization system 10 may network enterprise resource planning, a transportation management system, a warehouse management system, and the like. That is, the standard interface 30 may provide a knowledge-based service for optimal decision making of the shipper-oriented smart logistics network by interconnecting a reference information system, an order management system (OMS), the warehouse management system (WMS), the transportation management system (TMS), and the like, with the integrated optimization system 10 through the logistics integrated database 20.

A functional structure of the optimization process is classified into a C&C center and a carbon emission amount for each section, and basic information is classified into a shipper, a transport company, a center, a product group, a product, a customer, a vehicle type, a vehicle, and a driver, and the like.

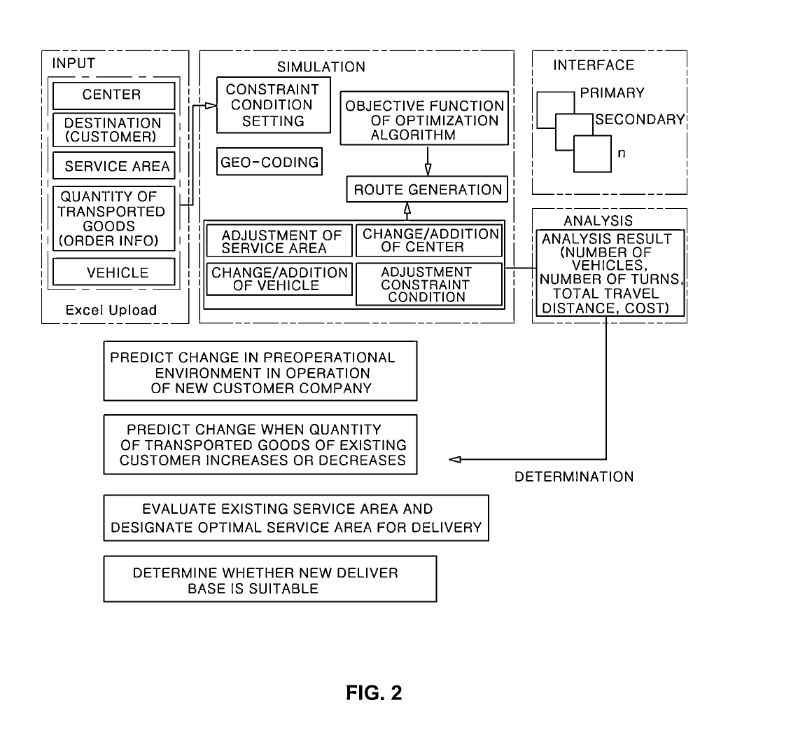

FIG. 2 is a process to describe a logistics network optimization module and a simulation module of an integrated optimization system. Using the integrated optimization system, a logistics base positioned between suppliers may collectively and thoroughly analyze a logistics system to be transferred to an integrated logistics center using a plurality of transport means and a corresponding logistics center, and may design and operate an optimal logistics network.

Therefore, it is possible to optimize a transport/delivery route using optimization and time efficiency, to provide induction of an optimal route of an associated transport, and logistics cost, a consumed time, a carbon emission amount, and the like of a corresponding route when a transport is completed, using a process of an environment-friendly transport means, and also to figure out which result is best suitable for each optimization purpose.

The logistics base optimization system of the present invention sequentially proceeds to an analysis process through an input process, a simulation process, and an interface process. The analysis process proceeds to a determination process while performing feedback to a route generation of the simulation process.

Initially, during the input process, basic information such as a center, a destination (customer), a service area, the quantity of transported goods (order information), a vehicle, and the like is uploaded in an excel program on a computer. When the basic information is uploaded, a route is generated by setting a constraint condition and then performing geo -coding during the simulation process.

The route generation is adjusted based on adjustment of an objective function of an optimization algorithm and the service area, change/addition of the center, change/addition of the vehicle, and adjustment of the constraint condition. The objective function is a delivery plan of the minimum cost and a delivery plan for the lowest CO₂.

Therefore, through the route generation, a primary order to an n^{th} order are provided via an interface manager during the interface process. Here, by proceeding from the interface process to an analysis process, while feeding back the number of vehicles, the number of turns, a total travel distance, and cost to the simulation process as a result analysis, the analysis process proceeds to the determination process.

During the determination process, the logistics base optimization system predicts a change in a preoperational environment in an operation of a new customer company, evaluates an existing service area, designates an optimal service area for delivery, predicts a change when the quantity of transported goods of an existing customer increases or decreases, and determines whether a new delivery base is suitable.

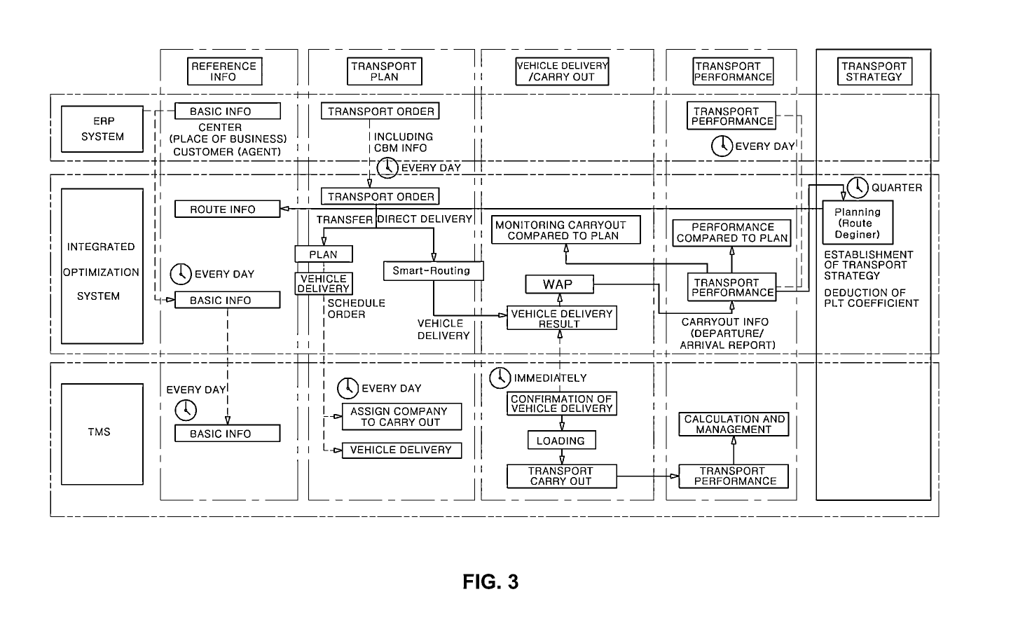

FIG. 3 is a process in which a reference information step, a transport plan step, a vehicle delivery/carryout step, a transport performance step, and a transport strategy step are performed with an enterprise order information (ERP) system, an integrated optimization system, and an enterprise executive system (TMS).

In the reference information step, the enterprise order information system's basic information of a center (place of business) and a customer (agent) is transmitted every day to the smart logistics network as basic information of the integrated optimization system. The integrated optimization system's basic information of the center (place of business) and the customer (agent) is transmitted to the enterprise order information system every day as basic information.

In the transport plan step, the enterprise order information system transmits a transport order including cubic meter (CBM) information as a transport order of the integrated optimization system every day. Therefore, transfer from the transport order is imprinted as a plan and a direct delivery from the transport order is imprinted as smart routing. According to the plan of the integrated optimization system, the enterprise executive system assigns a company to carry out and a vehicle delivery as a schedule order every day. Route information of the integrated optimization system is transmitted to the plan.

In the transport plan step, the vehicle delivery result of smart routing is transmitted to a wireless access protocol (WAP) as the vehicle delivery result of the vehicle delivery/carryout step. The vehicle delivery result of the integrated optimization system immediately is received as a confirmation of the vehicle delivery in the enterprise executive system. The enterprise executive system performs a transport carryout through loading and performs adjustment and management through transport performance in the transport performance step.

In the vehicle delivery/carryout step, transport performance is performed as carryout information (departure/arrival report) using the WAP of the integrated optimization system. The transport performance of the transport performance step is received as the transport performance of the ERP system every day. Therefore, the transport performance of the integrated optimization system is transmitted for monitoring carryout compared to plan in the vehicle delivery/carryout step and performance compared to plan in the transport performance step. Also, as the transport performance of the integrated optimization system, transport strategy of planning (route designer) is established and a PLT coefficient is deduced for each quarter in the transport strategy step. The planning is transmitted as the route information of the aforementioned reference information step.

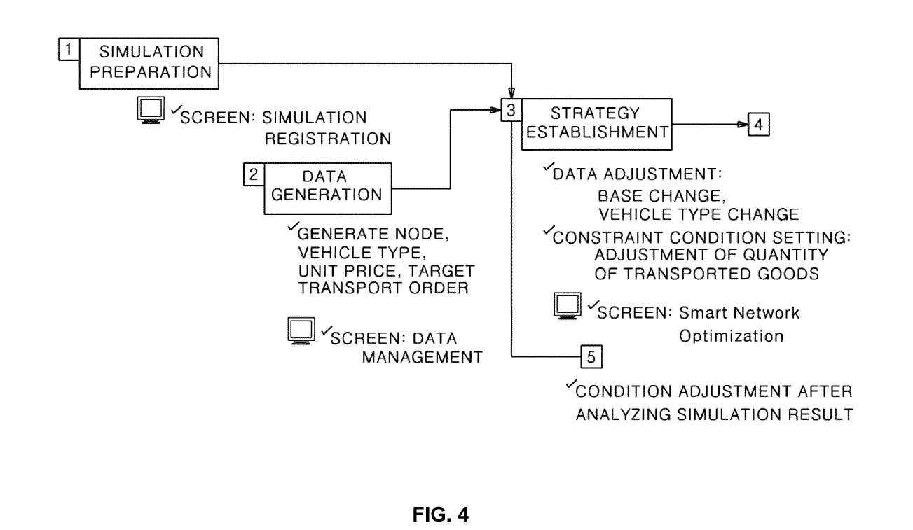

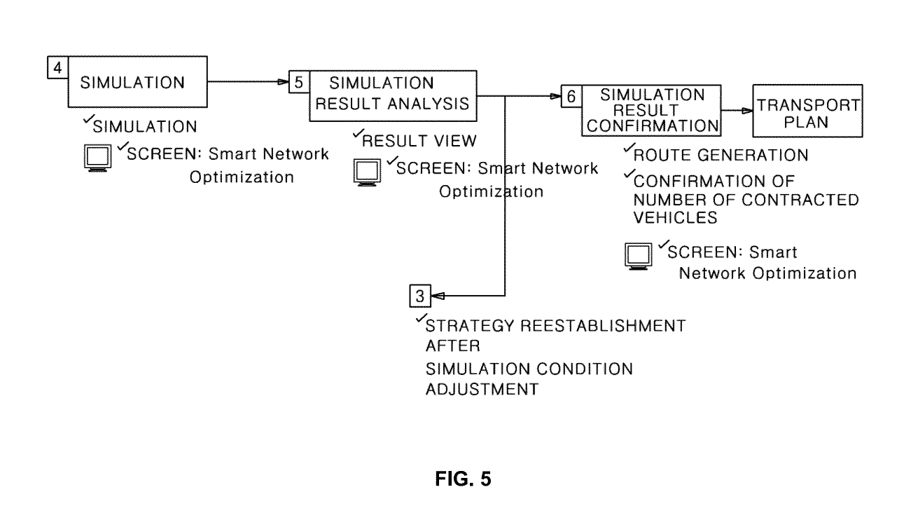

FIGS. 4 and 5 are processes performed in a simulation process. As shown in FIG. 4, a simulation preparation, a data generation, and a strategy establishment are performed. The simulation preparation registers a simulation on a screen, and the data generation generates a node, a vehicle type, a unit cost, and a target and transport order, and manages data on the screen.

The strategy establishment followed by the simulation preparation and the data generation optimizes a smart network on the screen by changing a base and the vehicle type as data adjustment, and by adjusting the quantity of transported goods as constraint condition setting. Also, the strategy establishment performs the conditional adjustment after analyzing the simulation result of FIG. 5.

The strategy establishment proceeds to a simulation, a simulation result analysis, a simulation result confirmation, and a transport plan of FIG. 5. The simulation optimizes the smart network on the screen as a simulation, and the simulation result analysis optimizes the smart network on the screen as a result view. Here, after adjusting the simulation condition, the strategy is reestablished.

The simulation result confirmation optimizes the smart network on the screen through route generation and confirmation of the number of contracted vehicles. The simulation preparation, the data generation, and the strategy establishment, the simulation, the simulation result analysis, and the simulation result confirmation are performed by a supply chain management (SCM).

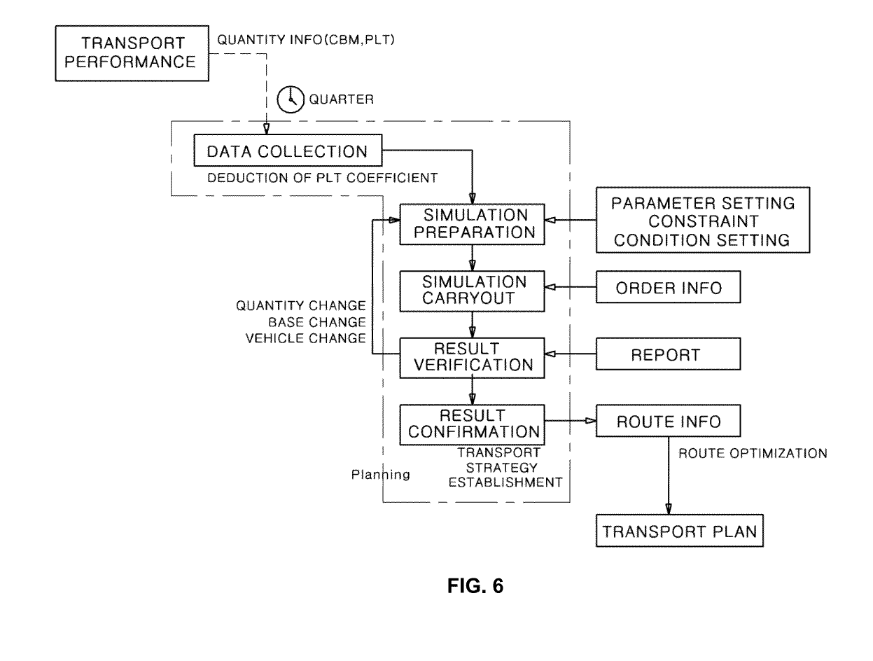

FIG. 6 is a flowchart illustrating planning of the transport strategy step in detail. The simulation preparation is performed by collecting per-quarter planning data with respect to quantity information (CBM and PLT) and by deducing a PLT coefficient as transport performance. Here, the simulation preparation receives a quantity change, a base change, and a vehicle change as the result verification together with a parameter setting and a constraint setting.

Next, the simulation carryout of planning is performed by receiving order information and the result verification of report is performed. The result confirmation of planning is transmitted to the transport plan step by performing route optimization using route information through establishment of a transport strategy.

As the simulation constraint condition, a relay-able base (node and hub) is predefined. The route presumes a shuttle operation and thus, returning may be performed or may not be performed. The quantity of returned goods is one quarter (1/4) level and has nothing to do with a loading rate. The fare of the contracted vehicle is calculated based on a round trip.

Also, as the constraint condition, a transport quantity order of the day is processed on the day and an available contracted vehicle type is predefined, processing capacity of a base is infinite, and there is no processing time. As the constraint condition, the total quantity/base reference (not a center) is used and a section distance uses a road (map) distance.

Also, as the constraint condition, 1PLT=1CBM: slightly different, but irrelevant in a system. The returning order is provided in the same form as a transport/delivery order and there is no PLT split. Transportability (link) between bases is predefined and every base has the transportability. As the constraint condition, the objective function proceeds as a cost minimization concept and proceeds to a priority of the following day when a lead time does not fit.

Accordingly, the transport strategy established as the planning result includes route information, the number of contracted vehicles for each route, and the number of contracted vehicles for each center.

Meanwhile, in a network optimization function, “Turn (load)” relates coordinates, a center reference angle, a center reference distance, a target loading rate, forecasting information, a customer entry condition (master and order), a further distance—first dispatch of vehicle (selection, Seed Allocation), a customer point calculation of a neighboring turn, and a customer addition to an optimal turn.

“Cargo matching (Matching)” relates to adding cargo to an optimal vehicle (Turn) from the given vehicle delivery result. “Return center (Return)” relates to a return center management for an associated delivery after the delivery completion. “Optimization (route optimization)” relates to optimizing a route after a manual vehicle delivery adjustment and to swapping a customer when movement between turns is allowed.

“The same customer (delivery point)” relates to management of recipients positioned at the same position. When there are both delivery and collection together, a collection schedule is generated after a delivery schedule is generated.

“Service area (Area)” relates to support of large, medium, and small service areas, and a direction of a vehicle is management of preferred areas of line 1, line 2, and line 3. In “route”, an essential route indicates observance of a predefined route and a route reference is applied based on a route circumstance.

“Temperature” is classified into a room temperature, a refrigerator temperature, and a freezer temperature, and thereby is managed. The room temperature, the refrigerator temperature, and the freezer temperature are mixed and thereby are managed, and are managed using a temperature partition (fixed type and variable type) of the vehicle.

“Vehicle delivery priority (Priority)” relates to a priority of a designated vehicle, a designated vehicle type, and a time constraint.

“Order split (Split)” is performed when the quantity is greater than a predetermined value and is not performed when the quantity is less than the predetermined value. “Requested time” is used to manage customer time strictness, to observe a delivery request time of an order, and to apply an allowance time of the constraint condition.

“Average value” relates to a speed, a vehicle entry time, a parking time, an entry delay, a loading time (based on CBM), and an unloading time (based on CBM). “Maximum value” relates to the number of turns, the number of customers (recipients), an operation time, a travel distance, a loading rate, and a standby time. “Minimum value” relates to a loading rate and managing whether there is a vehicle delivery less than the minimum loading rate.

“Map” relates to a straight line distance, a distance on the map (using road information), and a performance distance (using a geographical positioning system, GPS).

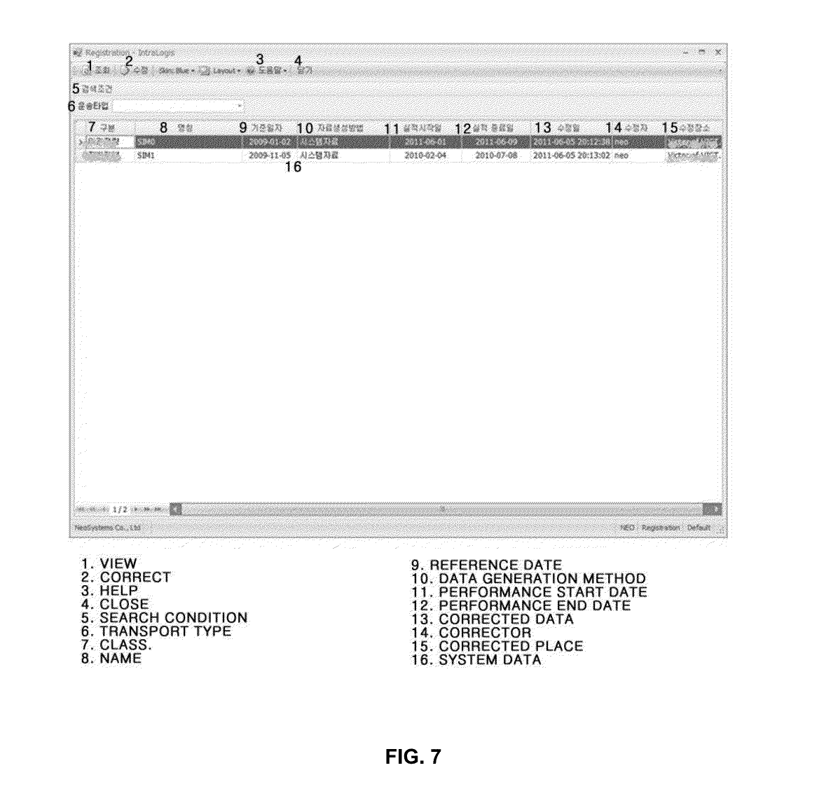

FIGS. 7 through 13 are views displayed on a screen of each item using an interface manager.

The screen of FIG. 7 relates to a TMS (Transportation Management System)—transport strategy-basic-general information—simulation registration of a 3PL (Third Party Logistics) in a menu of transport strategy. A program ID prepares a transfer/direct delivery simulation as a simulation registration item.

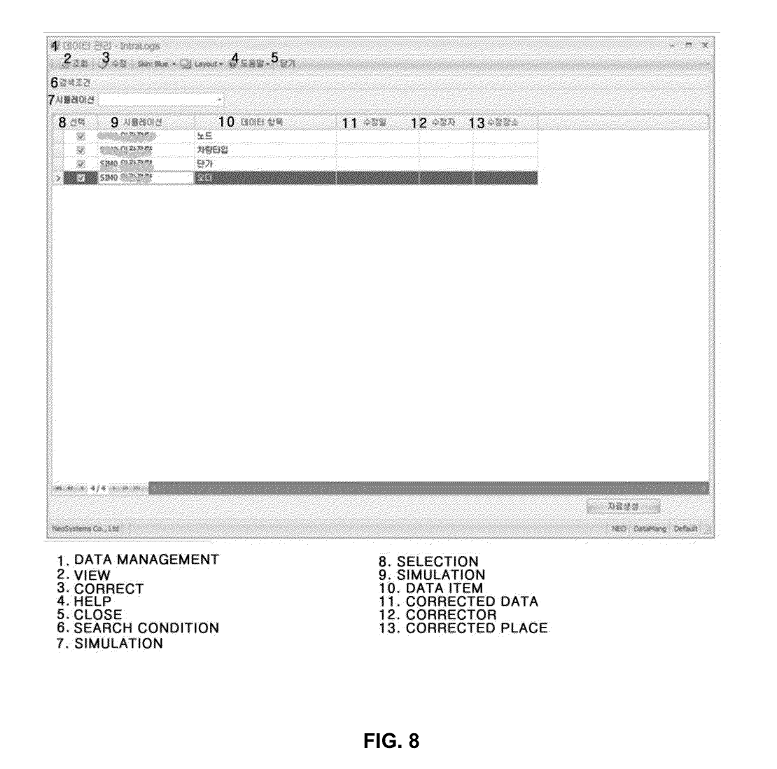

The screen of FIG. 8 relates to a TMS—transport strategy-basic-general information—data management of a 3PL in the menu of transport strategy. The program ID generates data as a data management item for each simulation.

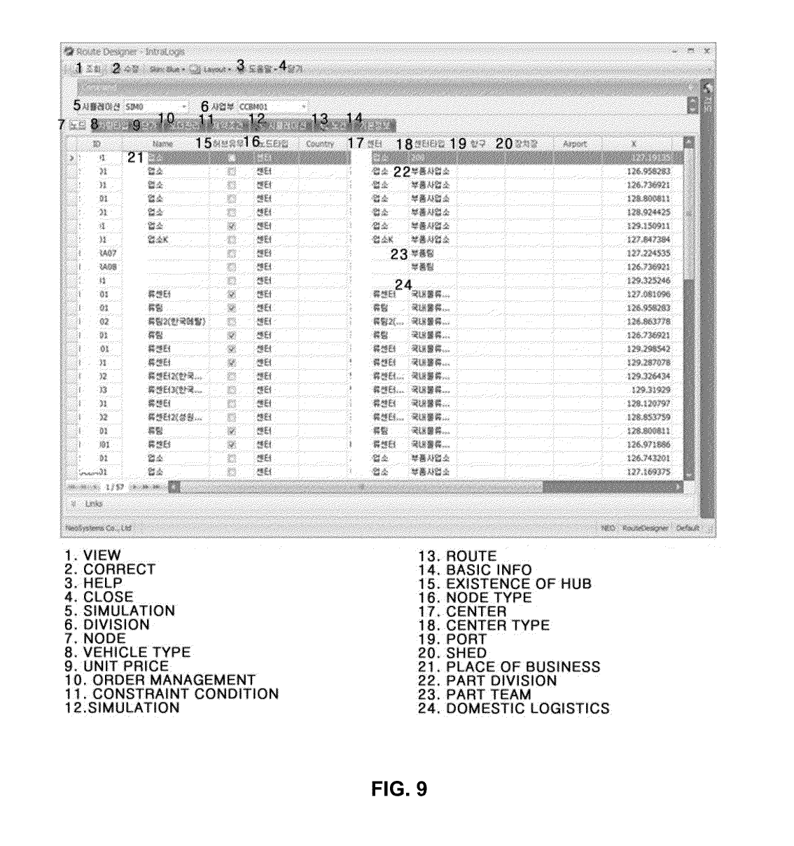

The screen of FIG. 9 relates to a TMS—transport strategy-basic-general information—router designer of a 3PL in the menu of transport strategy. The program ID generates node data as a node configuration item of the router designer.

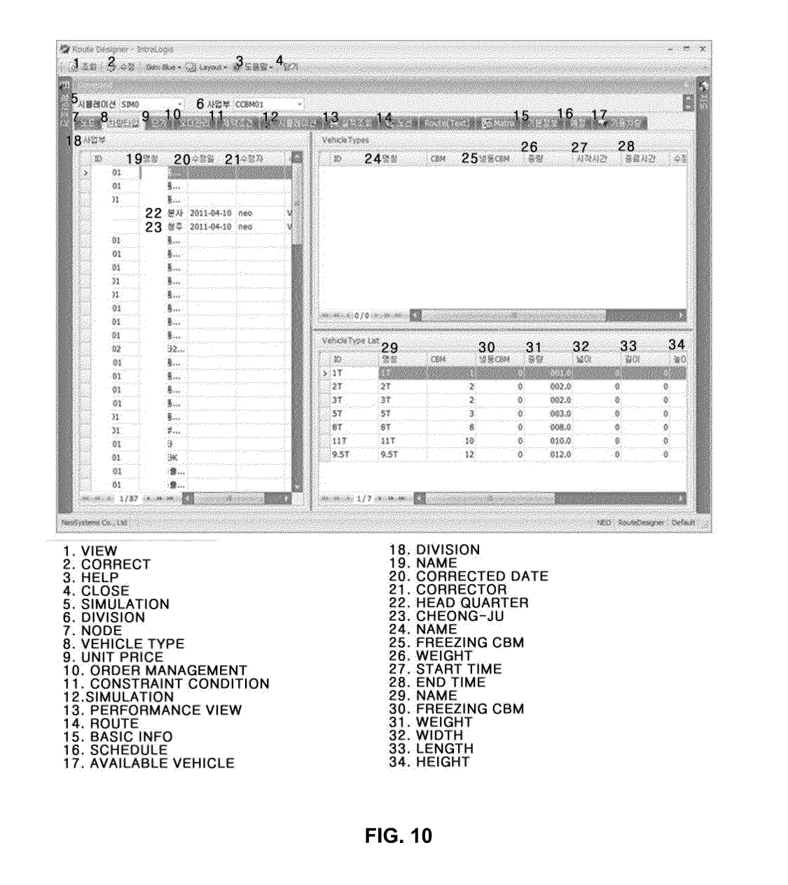

The screen of FIG. 10 relates to a TMS—transport strategy-basic-general information—router designer of a 3PL in the menu of transport strategy menu. The program ID generates vehicle type data as a vehicle type item of the router designer.

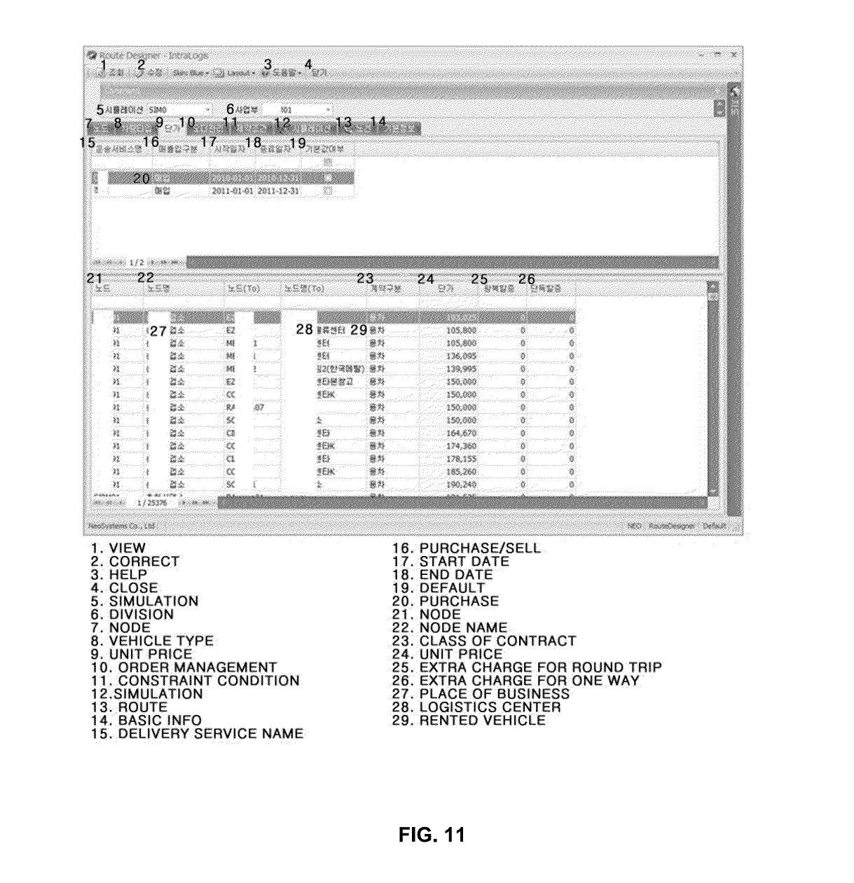

The screen of FIG. 11 relates to a TMS—transport strategy-basic-general information—router designer of a 3PL in the menu of transport strategy. The program ID generates unit cost data as a unit cost item of the router designer.

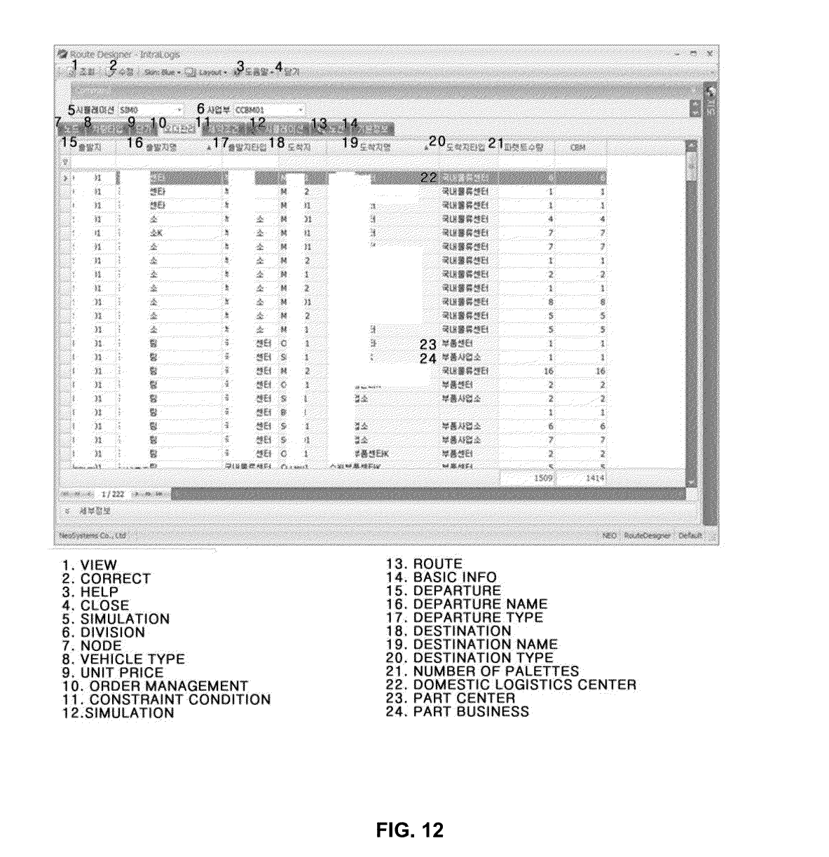

The screen of FIG. 12 relates to a TMS—transport strategy-basic-general information—router designer of a 3PL in the menu of transport strategy. The program ID generates target transport order data as an order management item of the router designer.

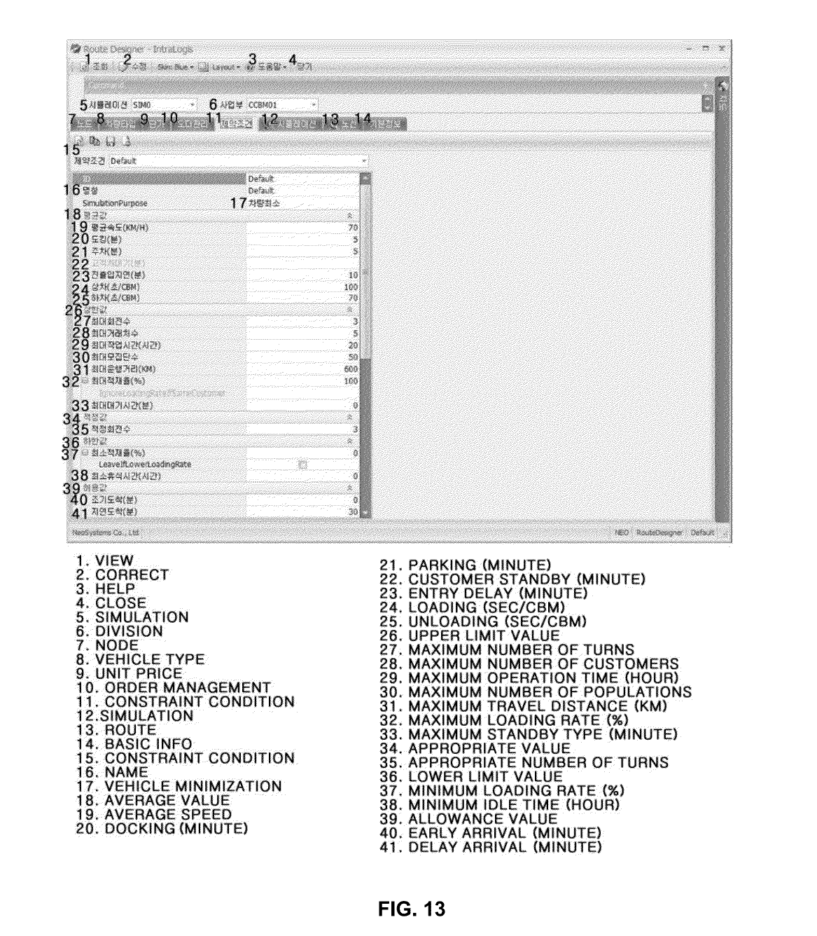

The screen of FIG. 13 relates to a TMS—transport strategy-basic-general information—router designer of a 3PL in the menu of transport strategy. The program ID generates strategy establishment, that is, constraint condition as a constraint condition item of the router designer.

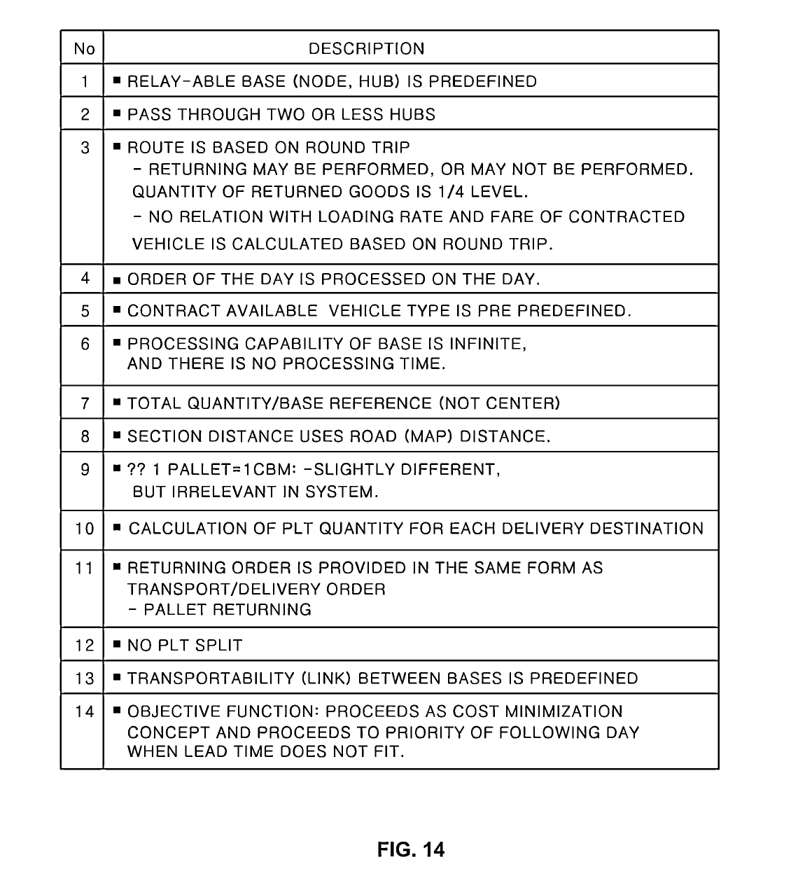

FIG. 14 is a process of transport strategy constraint condition illustrating constraint condition items of a router designer.

“ID and name” of the constraint condition, and an objective function relate to a peak section of ID for item classification in storing, and to a busy season of a constraint condition name. The objective function selects the minimum vehicle, the operation time minimization, cost minimization, and equivalent distribution.

“Average value” of the constraint condition is classified into an average operation speed, a time used for docking, a time used for parking, a standby time, a time delayed for entry, a time delayed for loading, and a time used for unloading.

“Upper limit value” of the constraint condition is classified into the maximum number of turns of a single vehicle, the maximum number of routings of the single vehicle, a time used for operation, the maximum number of populations (genetic algorithm random route generation), the maximum operable time of the single vehicle, a maximum loading rate of the single vehicle, and the maximum standby time (just before unloading) for each base.

“Lower limit value” of the constraint condition is classified into the maximum loading rate of the single vehicle, whether to perform a vehicle delivery when a loading rate is less than the maximum loading rate, and an idle time. “Allowance value” is classified into a time input when a vehicle arrives earlier than an estimated time and a time input when the vehicle arrives later than the estimated time.

“Allowableness” of the constraint condition allows loading by splitting a single order to another vehicle, allows products of a plurality of vehicle owners to be mixed and thereby be loaded to a single vehicle, allows arrangement of a refrigerator vehicle with respect to room temperature products, and allows arrangement of a freezer vehicle with respect to room temperature products.

“Options” of the constraint condition moves a vehicle to a further place as the routing result to thereby perform an inverse delivery, establishes a plan based on an actual distance of a map, slows down a speed, generates and processes a loading dock schedule, does not consider a vehicle weight when calculating and processing a loading rate, and does not consider a vehicle CBM when calculating and processing the loading rate.

Also, when “turn” is generated in a schedule generation standard of “options”, “true” adjusts a loading schedule of the center by calculating the first customer arrival time (requested time). “False” generates a loading schedule at an open time of the center regardless of the first customer schedule.

In the case of whether to use a preferred aspect of “options”, “true” assigns a vehicle in which a direction (preferred service area) is not set and “false” does not assign a vehicle in which the direction (preferred service area) is not set. “Route use” determines whether to perform optimization using route information.

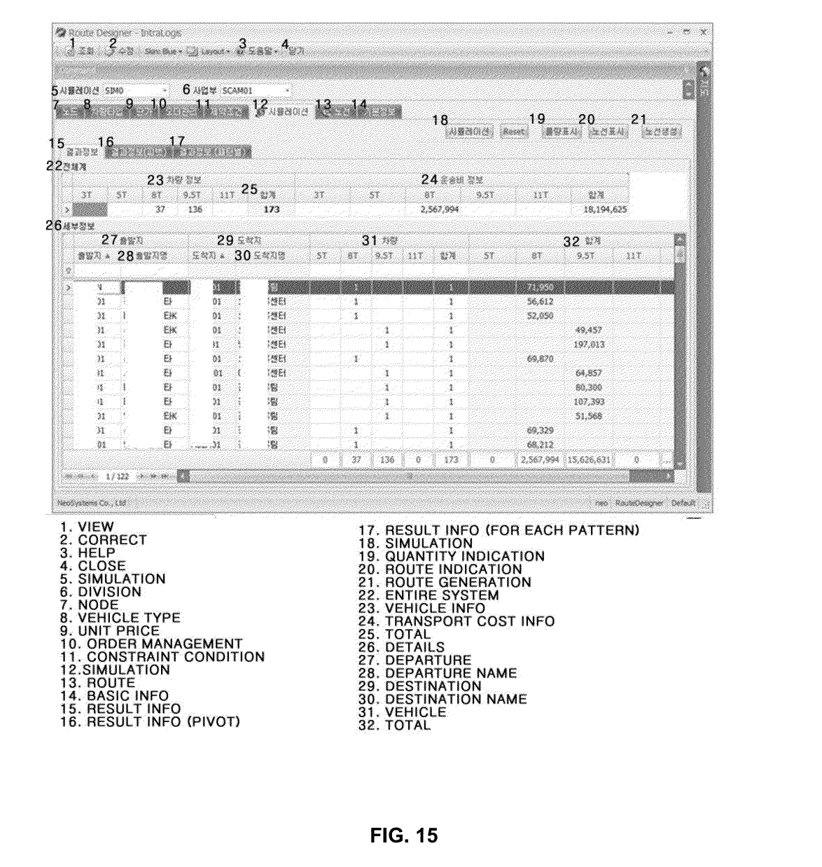

FIGS. 15 through 17 are views displayed on a screen of each item using an interface manager.

The screen of FIG. 15 relates to a TMS—transport strategy-basic-general information—router designer of a 3PL in the menu of transport strategy. The program ID refers to a simulation and a simulation constraint condition of the router designer.

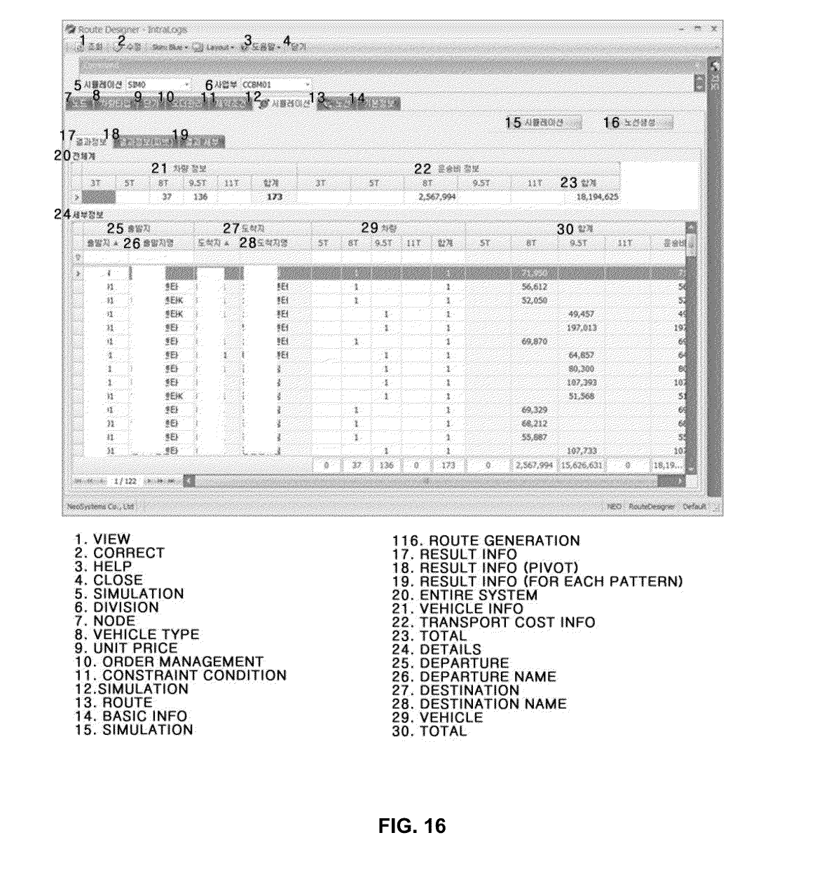

The screen of FIG. 16 relates to a TMS—transport strategy-basic-general information—router designer of a 3PL in the menu of transport strategy. In the program ID, the performance view of the router designer relates to a simulation result analysis and strategy reestablishment after adjusting the constraint.

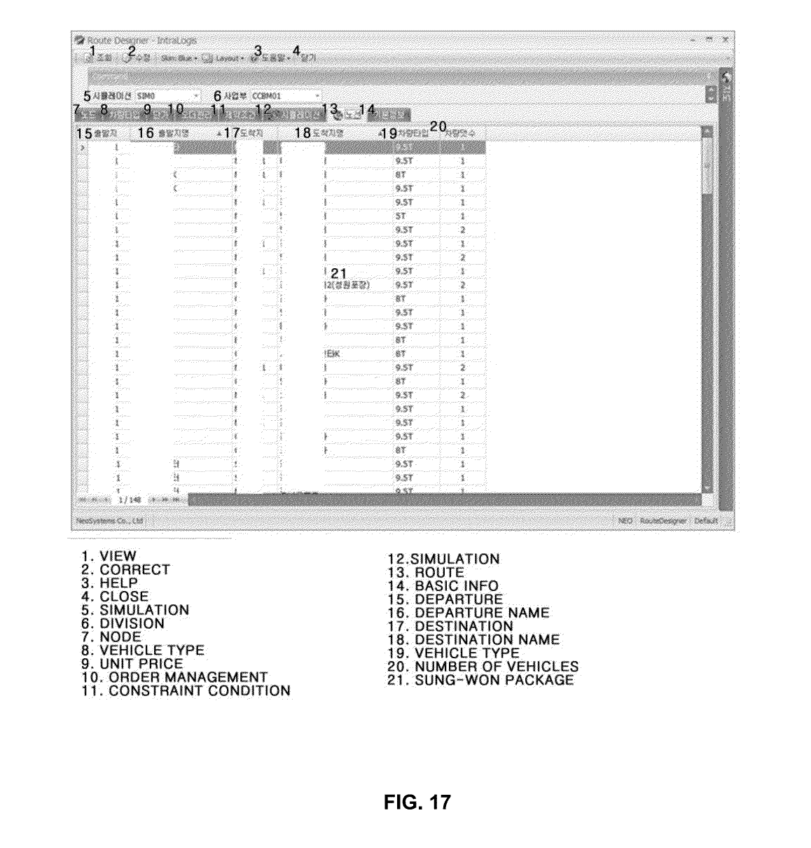

The screen of FIG. 17 relates to a TMS—transport strategy-basic-general information—router designer of a 3PL in the menu of transport strategy. In the program ID, the simulation result confirmation of the router designer performs route generation only with respect to “transfer” and expands the number of contracted vehicles and uses strategy information in the transport contract.

Meanwhile, a vehicle route plan issue of a hybrid multi hub-and-spoke system determines the number and positions of hubs, and a vehicle size, the number of vehicles, and a contract and operation type (round trip or one way, long term contract, a daily rented vehicle, and the like) with respect to a main route in charge of relay transport between hubs, a branch route in charge of transport among a hub, a sending office, and a receiving office, and a direct route performing direct transport between each sending office and each receiving office.

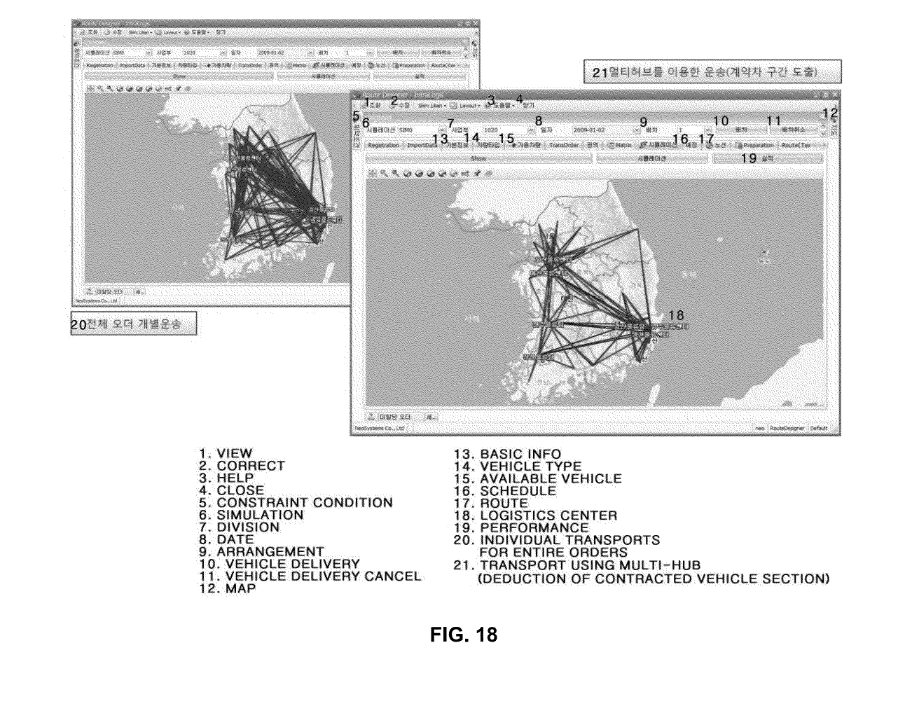

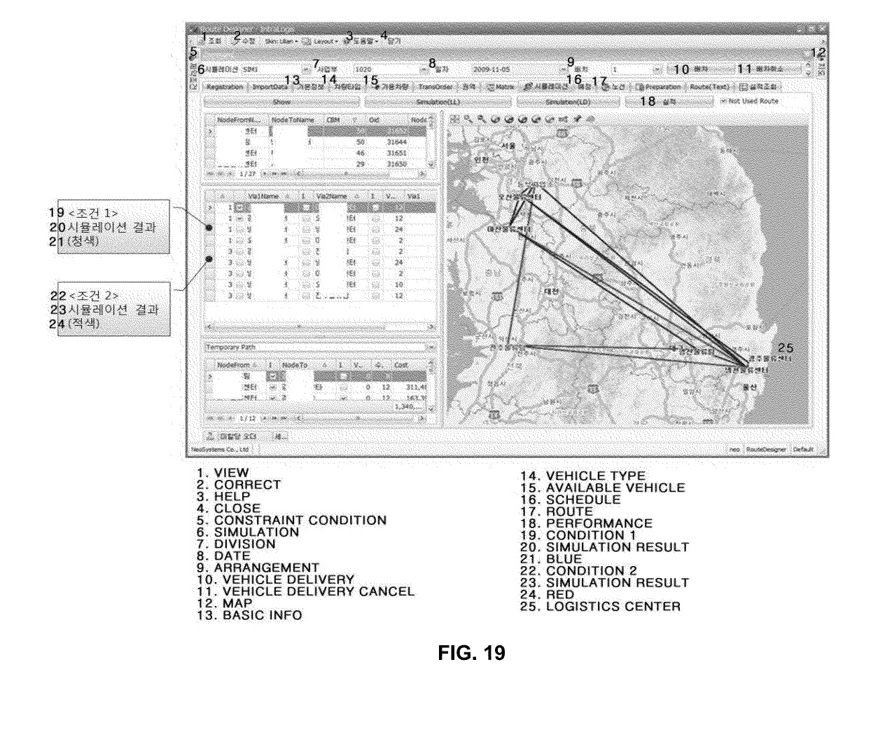

FIGS. 18 and 19 are views displaying routes to describe a shipper-oriented logistics base optimization system of the present invention.

FIG. 18 shows individual transports for all the orders and a transport (deduction of contracted vehicle section) using a multi-hub, and FIG. 19 shows a simulation result of condition 1 and a simulation result of condition 2.

According to the exemplary embodiment of the present invention, it is possible to analyze load according to a change in the quantity and to predict the effect according to countermeasures through advance simulation. It is possible to draw a simulation result associated with a plurality of transport means.

Therefore, according to the embodiment of the present invention, it is possible to promote the optimal design and operation of an environment-friendly logistics network in consideration of optimization of a carbon emission amount by establishing a transport/delivery plan. Also, it is possible to establish a stable logistics network plan with a quicker time and lower cost for improving the effectiveness and efficiency of the logistics network.

Also, according to the exemplary embodiment of the present invention, it is possible to efficiently improve a complex logistics procedure through optimization of a carbon emission amount, and to strengthen the competitiveness of logistics by establishing a logistics optimization plan.

A shipper-oriented logistics base optimization system according to the exemplary embodiment of the present invention is not limited to the described exemplary embodiment. It is apparent to a skilled person in the art to which the present invention pertains that the embodiment of the present invention may be variously modified and changed within scope of the present invention.

Therefore, it is apparent that the modifications or changes are included in the scope of the present invention.

1. A shipper-oriented logistics base optimization system, wherein, through smart logistics networking with a logistics integrated database and a standard interface constructed and operated to generalize logistics related data by processing and analyzing collected information based on a total logistics information network and a current logistics situation survey together with an active logistics management optimization module and a simulation module in a server, the shipper-oriented logistics base optimization system is configured to perform:
an input process of receiving a center, a destination (customer), a service area, a quantity of transported goods (order information), and a vehicle in the optimization module and the simulation module;
a simulation process of a route generation by setting a constraint condition and then performing geo-coding;
an interface process of providing a primary order to an n^{th} order in an interface manager through the route generation;
an analysis process proceeding to a determination process while feeding back a number of vehicles, a number of turns, a total travel distance, and cost to the simulation process as a result analysis; and
the determination process of predicting a change in a preoperational environment in an operation of a new customer company, evaluating an existing service area, designating an optimal service area for delivery, predicting a change when the quantity of transported goods of an existing customer increases or decreases, and determining whether a new delivery base is suitable.

2. The system of claim 1, wherein the route generation receives an adjustment of an objective function of an optimization algorithm and the service area, change/addition of the center, change/addition of the vehicle, and adjustment of the constraint condition.

3. The system of claim 2, wherein the objective function is a delivery plan of the minimum cost and a delivery plan for the lowest CO₂.

4. A shipper-oriented logistics base optimization system, wherein a reference information step, a transport plan step, a vehicle delivery/carryout step, a transport performance step, and a transport strategy step are performed with an enterprise order information (ERP) system, an integrated optimization system, and an enterprise executive system (TMS) whereby an integrated optimization system of a smart logistics network
performs a simulation preparation by collecting per-quarter planning data with respect to quantity information (cubic meter (CBM) and PLT) and by deducing a PLT coefficient as transport performance,
performs a simulation carryout of planning by receiving order information and verifies a result of report, and
transmits a result confirmation of the planning to the transport plan step by performing route optimization using route information through establishment of a transport strategy.

5. The system of claim 4, wherein the simulation preparation receives a quantity change, a base change, and a vehicle change as the result verification together with a parameter setting and a constraint setting.

6. The system of claim 4, wherein the transport strategy established as the planning result includes a route information, a number of contracted vehicles for each route, and a number of contracted vehicles for each center.
